(19) United States
(12) Patent Application Publication
(10) Pub. No.: US 2014/0143468 A1
(43) Pub. Date: May 22, 2014

(54) REAL-TIME SAMPLING DEVICE AND METHOD THEREOF

(71) Applicant: Industrial Technology Research Institute, Chutung (TW)

(72) Inventors: Ying-Min CHEN, Chutung (TW); Wen-Chuan CHEN, Chutung (TW); Jing-Yi HUANG, Chutung (TW); Yi-Hsueh YANG, Chutung (TW); Feng-Chi LEE, Chutung (TW)

(73) Assignee: Industrial Technology Research Institute, Chutung (TW)

(21) Appl. No.: 14/062,613

(22) Filed: Oct. 24, 2013

(30) Foreign Application Priority Data
Nov. 16, 2012 (TW) 101142775

(51) Int. Cl. G06F 13/24

(52) U.S. Cl. CPC G06F 13/24
USPC 710/267

(57) ABSTRACT

A real-time sampling device for being coupled to a processing unit includes a first register, a second register, a third register, a trigger output element and a timer for outputting an interrupt signal. The first register externally receives and processes a first input signal to produce processed data. The second register retrieves the processed data from the first register upon receiving the interrupt signal, and the processing unit, upon receiving the interrupt signal, retrieves the processed data from the second register and performs calculation thereon to produce a processed data calculation value and temporarily store the processed data calculation value in the third register. The trigger output element outputs the processed data calculation value in the third register in real time upon receiving the interrupt signal. The real-time sampling device an be applied to digital control systems in order to perform real-time sampling on controlled subjects.

### CROSS-REFERENCE TO RELAXED APPLICATIONS

This application claims priority to Taiwanese Patent Application No. 101142775, filed on Nov. 16, 2012, the disclosure of which is hereby incorporated by reference he

### TECHNICAL FIELD

The technical field relates to a real-time sampling device and a method thereof, and more particularly, to a real-time sampling device applicable to a digital servo control system and method thereof.

### BACKGROUND

In recent years, embedded systems are flourishing. Many control systems employ embedded systems architectures to implement digital control in high-level servo systems using their powerful computing capability.

In general, most of the complex, high-level algorithms can be implemented through software. In terms of digitizing real systems, precision in system sampling time is a crucial factor for accurate digital controls. Users may choose the appropriate hardware and software to construct an embedded control system (such as a fast interrupt processor to reduce hardware delay, a hard real-time operating system to reduce software delay and the like) in the hope that the system can accurately sample feedback values periodically, and complete the control algorithm and send out the result before the end of the current cycle. Therefore, before digital servo control is implemented, the real-time performance of the system is assessed according to the system bandwidth to ensure that the system meets the requirements for digital control.

When implementing a digital control system with high-level algorithms through software, in addition to paying attention to whether the computing power of the system is sufficient enough, the real-time performance of the system also needs to be checked to ensure that the system can meet the digitalized conditions for fixed-period samplings. Under the constraints of these conditions, most of the embedded servo control systems are applicable only to controls of low bandwidths and simple calculations. As for high-bandwith and calculation-complex controls, the control results are often not desirable due to poor real-time performance of the system.

### SUMMARY

The present disclosure provides a real-time sampling device coupled to a processing unit. The real-time sampling device may include: a timer for outputting an interrupt signal; a first register for externally receiving a first input signal and processing the first input signal to produce first processed data; a second register coupled to the first register and the timer for retrieving the first processed data from the first register upon receiving the interrupt signal sent from the timer, and the processing unit, upon receiving the interrupt signal sent from the timer, retrieving the first processed data from the second register and performing calculation thereon to produce a first processed data calculation value; a third register coupled with the processing unit for receiving and temporarily storing the first processed data calculation value produced by the processing unit; and a trigger output element coupled with the third register and the timer for outputting the first processed data calculation value in the third register upon receiving the interrupt signal sent from the timer.

The present disclosure also provides a real-time sampling method, which may include the following steps of: (1) receiving a first input signal and processing the first input signal by a first register to produce first processed data; (2) retrieving the first processed data from the first register by a second register upon receiving an interrupt signal, and upon receiving the interrupt signal, retrieving the first processed data from the second register and performing calculation by a processing unit to produce a first processed data calculation value and transmit the first processed data calculation value to a third register; (3) receiving and temporarily storing the first processed data calculation value produced by the processing unit by the third register in order to transmit the first processed data calculation value to a trigger output element; and (4) outputting the first processed data calculation value in the third register by the trigger output element upon receiving the interrupt signal.

The real-time sampling device and method use the second register to retrieve the processed data from the first register in real time upon receiving the interrupt signal, such that the processing unit can retrieve the processed data from the second register upon receiving the interrupt signal, and the trigger output element can output the processed data calculation value produced by the processing unit and stored in the third register upon receiving the interrupt signal, thereby eliminating delay between the time at which the interrupt signal is sent from the timer and the time at which processing unit retrieves the processed data.

### BRIEF DESCRIPTION OF THE DRAWINGS

The present disclosure can be more fully understood by reading the following detailed description of the preferred embodiments, with reference made to the accompanying drawings, wherein:

FIG. 1A is a schematic diagram depicting basic components of a real-time sampling device in accordance with the present disclosure;

FIG. 1B is a schematic diagram depicting basic components of a modification of the real-time sampling device in accordance with the present disclosure;

FIG. 2 is a flowchart illustrating a real-time sampling method in accordance with the present disclosure;

FIG. 3A is a schematic diagram depicting the real-time sampling device in accordance with a first embodiment of the present disclosure;

FIG. 3B is a schematic diagram depicting the real-time sampling device in accordance with a second embodiment of the present disclosure;

FIG. 3C is a schematic diagram depicting the real-time sampling device in accordance with a third embodiment of the present disclosure; and

FIG. 4 is a drawing illustrating the effect of the real-time sampling device and method thereof in accordance with the present disclosure.

### DETAILED DESCRIPTION OF THE EMBODIMENTS

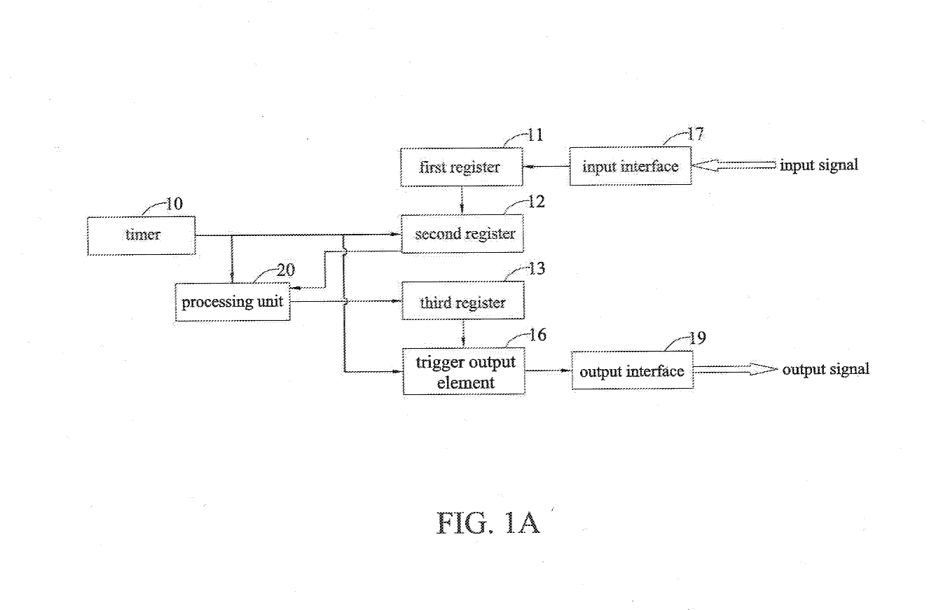

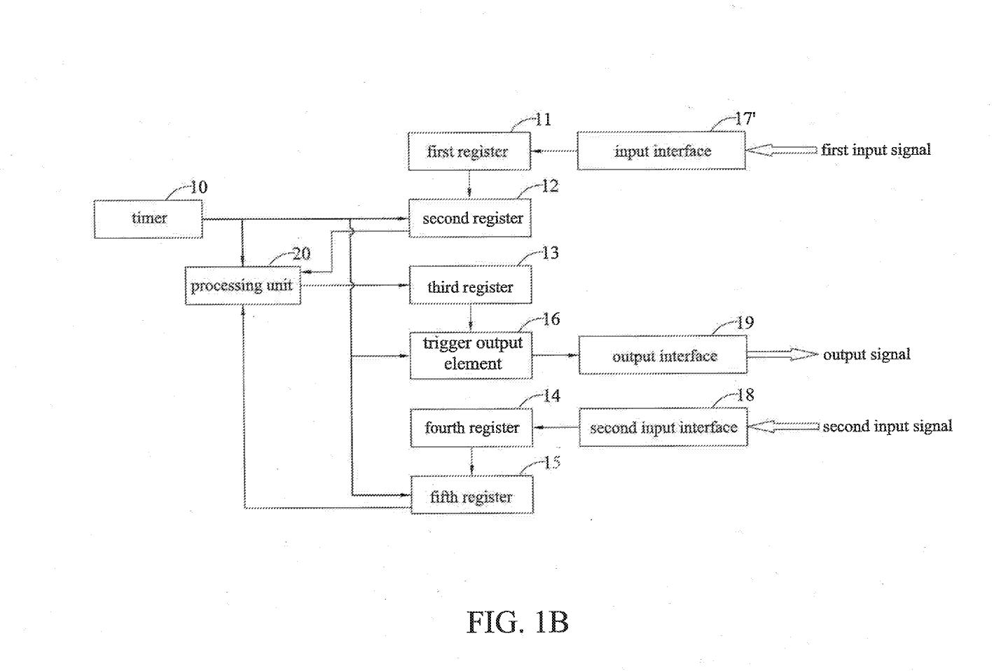

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout. Refer to FIG. 1A, a real-time sampling device of the present disclosure mainly includes a timer 10, a first register 11, a second register 12, a third register 13 and a fourth register 14, and a trigger output element 16, an input interface 17 and an output interface 19 coupled together via buses. The real-time sampling device of the present disclosure is coupled to a processing unit 20.

The timer 10 can output an interrupt signal. The first register 11 can receive an external input signal through the input interface 17 and perform processing of the input signal to produce processed data and store the processed data.

The second register 12 can retrieve the processed data from the first register 11 upon receiving the interrupt signal sent from the timer 10. The processing unit 20 can retrieve the processed data from the second register 12 upon receiving the interrupt signal sent from the timer 10, so as to perform calculations on the processed data to produce a processed data calculation value, and transmit this processed data calculation value to the third register 13.

The third register 13 can receive, and temporarily store the first processed data calculation value produced by the processing unit 20.

The trigger output element 16 can output the processed data calculation value to the output interface 19 upon receiving the interrupt signal sent from timer 10.

Traditionally, there is a delay between the time at which the processing unit 20 retrieves the processed data from the first register 11 upon receiving the interrupt signal sent from the timer 10 and the time at which the interrupt signal is sent, which causes further delay in the processing unit 20 performing calculation on the processed data and then storing the result in the third register. On the other hand, the second register 12 of the present disclosure immediately retrieves the processed data from the first register 11 in real time upon receiving the interrupt signal sent from the timer 10, such that the processing unit 20 can retrieve the processed data from the second register 12 for subsequent calculation upon receiving the interrupt signal sent from the tinier 10, and the trigger output element 16 can immediately output the processed data calculation value produced by the second register 12 in real time upon receiving the interrupt signal sent from the timer 10. As a result, real-time sampling can be achieved.

Referring to FIG. 1B, the real-time sampling device of the present disclosure can further include a fourth register 14, a fifth register 15 and a second input interface 18 coupled together by buses, and the input interface 17 to which the first register 11 is connected shown in FIG. 1A is a first input interface 17′ in FIG. 1B.

The fourth register 14 can receive a second input signal sent by the timer 10, and then perform processing on the second input signal to produce and store second processed data.

The fifth register 15 can retrieve the second processed data from the fourth register 14 upon receiving the interrupt signal sent from the timer 10, and the processing unit 20 can retrieve the second processed data from the fifth register 15 upon receiving the interrupt signal sent from the timer 10, and perform calculation on the second processed data to produce and transmit a second processed data calculation value to the third register 13.

The third register 13 can receive and temporarily store the second processed data calculation value produced by the processing unit 20, and the trigger output element 16 can output the second processed data calculation value to the output interface 19 upon receiving the interrupt signal sent from the timer 10.

Thus, in the modification of the real-time sampling device shown in FIG. 1B, upon receiving the interrupt signal from the timer 10, the processing unit 20 simultaneously retrieves the first processed data sent from the second register 12 and the second processed data from the fourth register 14 and performs calculation thereon. Then, the processing unit 20 transmits the first and second processed data calculation values to the third register 13 for temporary storage. The third register 13 outputs the temporarily stored first and second processed data calculation values to the output interface 19 upon receiving the interrupt signal sent from the timer 10.

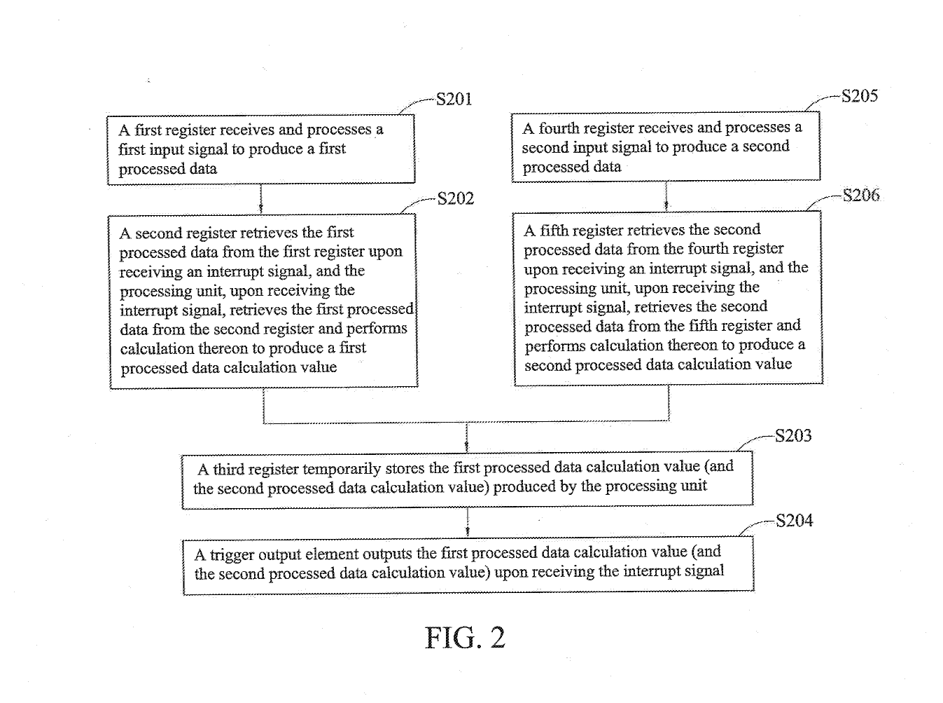

Referring to FIG. 2, a real-time sampling method of the present disclosure is illustrated. In step S201, a first input signal is received by a first register, and the first input signal is processed by the first register to produce and store first processed data. Generally speaking, before step S201, the period of an interrupt signal can be preset. In addition, step S205 can be performed at the same time as step S201. In step S205, a second input signal is received and processed by a fourth register to produce and store second processed data.

In step S202, the first processed data are retrieved from the first register by a second register upon receiving an interrupt signal, and the first processed data are retrieved from the second register by a processing unit upon receiving the interrupt signal, the first processed data are processed by the processing unit to produce a first processed data calculation value, which is transmitted to a third register. In addition, step S206 can be performed at the same time as step S202. In step S206, the second processed data are retrieved from the fourth register by a fifth register upon receiving an interrupt signal, and the second processed data are retrieved from the fifth register by the processing unit upon receiving the interrupt signal, the second processed data are processed by the processing unit to produce a second processed data calculation value, which is transmitted to the third register.

In step S203, the first processed data calculation value (and the second processed data calculation value) produced by the processing unit are temporarily stored by the third register, and the first processed data calculation value (and the second processed data calculation value) are transmitted to a trigger output element.

In step S204, the first processed data calculation value (and the second processed data calculation value) in the third register is/are outputted by the trigger output element upon receiving the interrupt signal.

From the illustrations in FIGS. 1A, 1B and 2 and their relevant descriptions, it can be understood that the real-time sampling device and method of the present disclosure can eliminate the delay between the time at which the interrupt signal is sent and the time at which sampling is performed traditionally occurred in the prior art, therefore achieving real-time sampling.

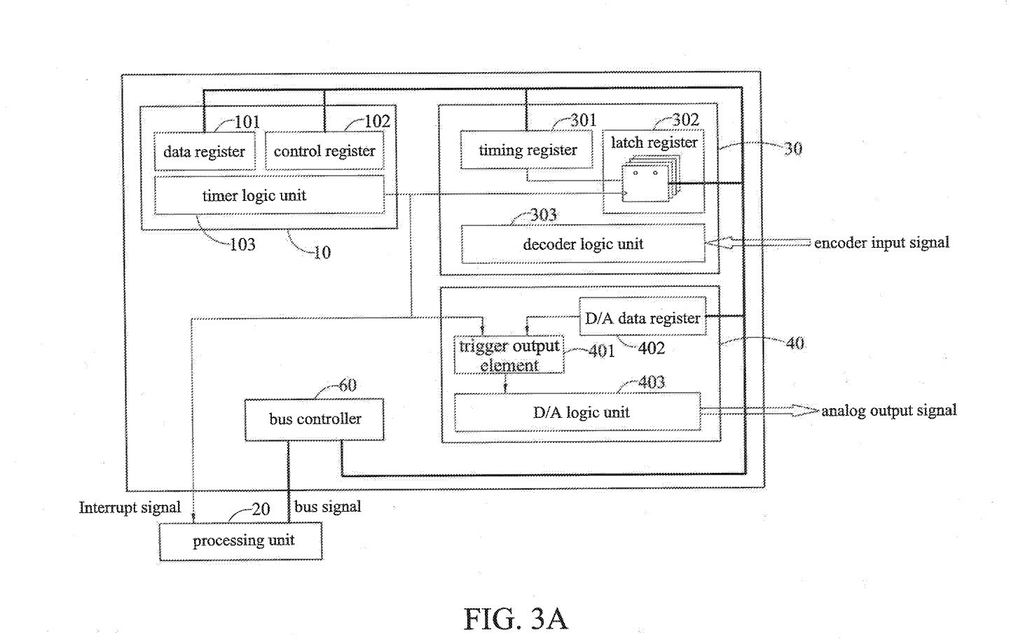

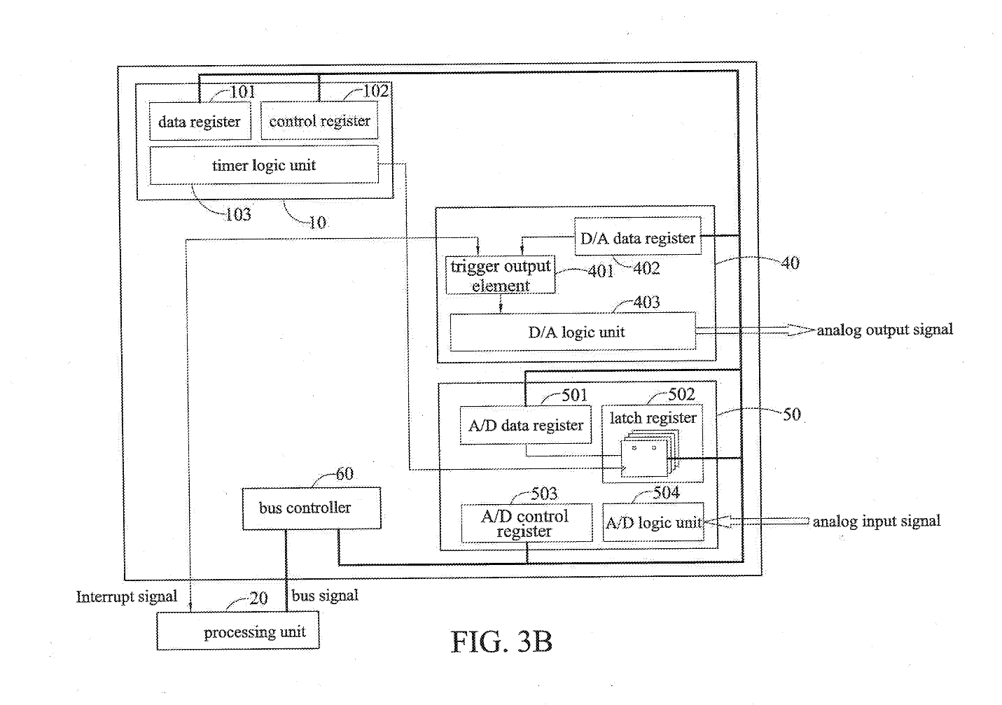

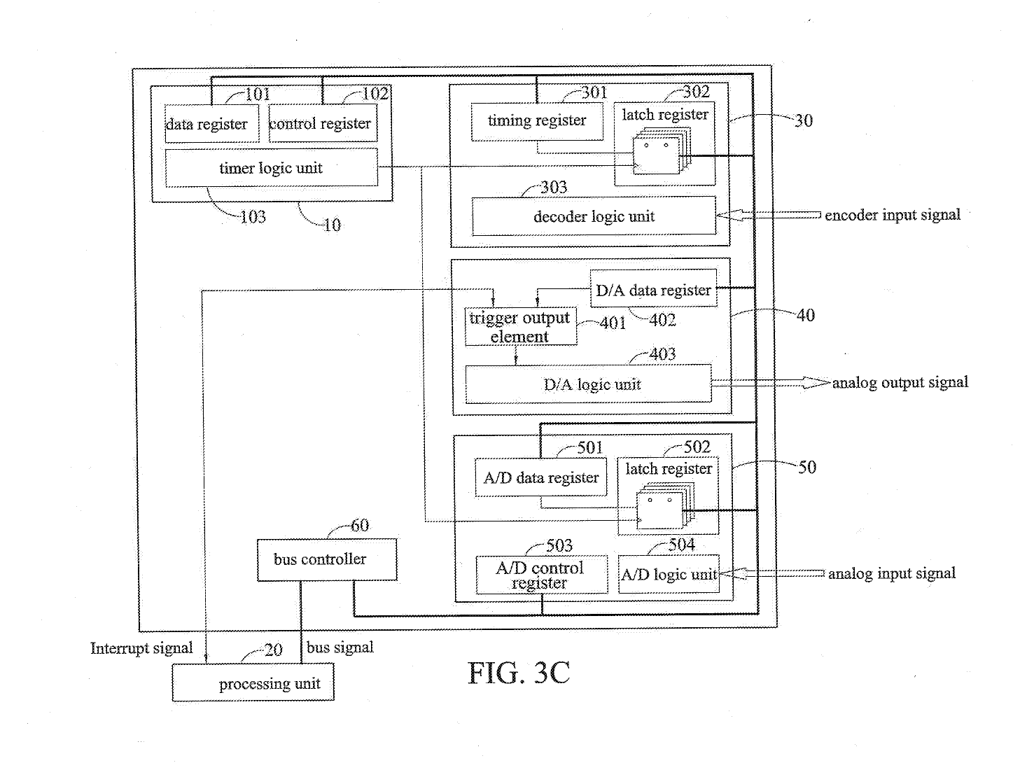

FIGS. 3A, 3B and 3C below illustrates the first, second and third embodiments of the present disclosure, respectively.

### First Embodiment

As shown in FIG. 3A, a real-time sampling device of the present disclosure is coupled to a processing unit 20. The real-time sampling device includes a timer 10, a decoder 30, a D/A converter 40 and a bus controller 60 coupled together by buses. The processing unit 20 can control the timer 10, the decoder 30, and the D/A converter 40 via the buses through the bus controller 60. It should be noted that specific implementations of the first register 11, the input interface 17, the second register 12, the third register 13, the trigger output element 16 and the output interface 19 shown in FIG. 1A correspond to a timing register 301, a decoder logic unit 303, a latch register 302, a D/A data register 402, a trigger output element 401 and a D/A logic unit 403, respectively.

The timer 10 can include a data register 101, a control register 102 and a timer logic unit 103, and is used for sending an interrupt signal to the processing unit 20, the latch register 302 of the decoder 30 and the trigger output element 401 of the D/A converter 40.

The decoder 30 can include the timing register 301, the latch register 302 and the decoder logic unit 303. The decoder logic unit 303 can receive an encoder input signal. The timing register 301 can perform counting on the encoder input signal and store the count value. The latch register 302, upon receiving the interrupt signal, retrieves the count value from the timing register 301. Then, the processing unit 20 retrieves the count value from the latch register 302 via a bus by the bus controller 60, and performs calculation on the count value to determine and store a voltage value into the D/A data register 402 of the D/A converter 40.

The D/A converter 40 includes the trigger output element 401, the D/A data register 402 and the D/A logic unit 403. The trigger output element 401, upon receiving the interrupt signal, retrieves the voltage value from the D/A data register 402 in real time, and the D/A logic unit 403 outputs the voltage value. The outputted voltage value is an output signal in the analog form.

### Second Embodiment

As shown in FIG. 3B, a real-time sampling device of the present disclosure is coupled to a processing unit 20. The real-time sampling device includes a timer 10, a decoder 30, an A/D converter 50 and a bus. controller 60 coupled together by buses. The processing unit 20 can control the timer 10, the decoder 30, and the A/D converter 50 via the buses through the bus controller 60. It should be noted that specific implementations of the first register 11, the input interface 17, the second register 12, the third register 13, the trigger output element 16 and the output interface 19 shown in FIG. 1B correspond to an A/D data register 501, an A/D logic unit 504, a latch register 502, a D/A data register 402, a trigger output element 401 and a D/A logic unit 403, respectively.

The timer 10 can send an interrupt signal to the processing unit 20, the latch register 502 of the A/D converter 50 and the trigger output element 401 of the D/A converter 40.

The A/D converter 50 can include the A/D data register 501, the latch register 502 and an A/D control register 503 and the A/D logic unit 504. The A/D control register 503 can receive an analog input signal. The A/D data register 501 performs conversion on the analog input signal and temporarily store a converted value. The latch register 502, upon receiving the interrupt signal, retrieves the converted value from the A/D data register 501. Then, the processing unit 20 retrieves the converted value from the latch register 502 via a bus by the bus controller 60, and performs calculation on the converted value to determine and store a voltage value into the D/A data register 402 of the D/A converter 40.

In the D/A converter 40, the trigger output element 401, upon receiving the interrupt signal, retrieves the voltage value from the D/A data register 402 in real time, and the D/A logic unit 403 outputs the voltage value. The output voltage value is an output signal in the analog form.

### Third Embodiment

As shown in FIG. 3C, a real-time sampling device of the present disclosure is coupled to a processing unit 20. The real-time sampling device includes a timer 10, a decoder 30, a D/A converter 40, an A/D converter 50 and a bus controller 60 coupled together by buses. The processing unit 20 can control the timer 10, the decoder 30, the D/A converter 40 and the A/D converter 50 via the buses through the bus controller 60. It should be noted that specific implementations of the first register 11, the first input interface 17′, the second register 12, the third register 13, the trigger output element 16, the output interface 19, the fourth register 14, the second input interface 18 and the fifth register 15 shown in FIGS. 1A and 1B correspond to the timing register 301, the decoder logic unit 303, the latch register 302, the D/A data register 402, the trigger output element 401, the D/A logic unit 403, the A/D data register 501; the A/D logic unit 504 and the latch register 502, respectively.

In FIG. 3C, the processing unit 20 retrieves the count value and the converted value from the latch registers 302 and 502, respectively, and calculates them as voltage value and stores them in the D/A data register 402, so that upon receives the interrupt signal sent from the timer 10, the trigger output element 401 can retrieve the voltage value stored in the D/A data register 402 and the D/A logic unit 403 can then output the voltage value in real time.

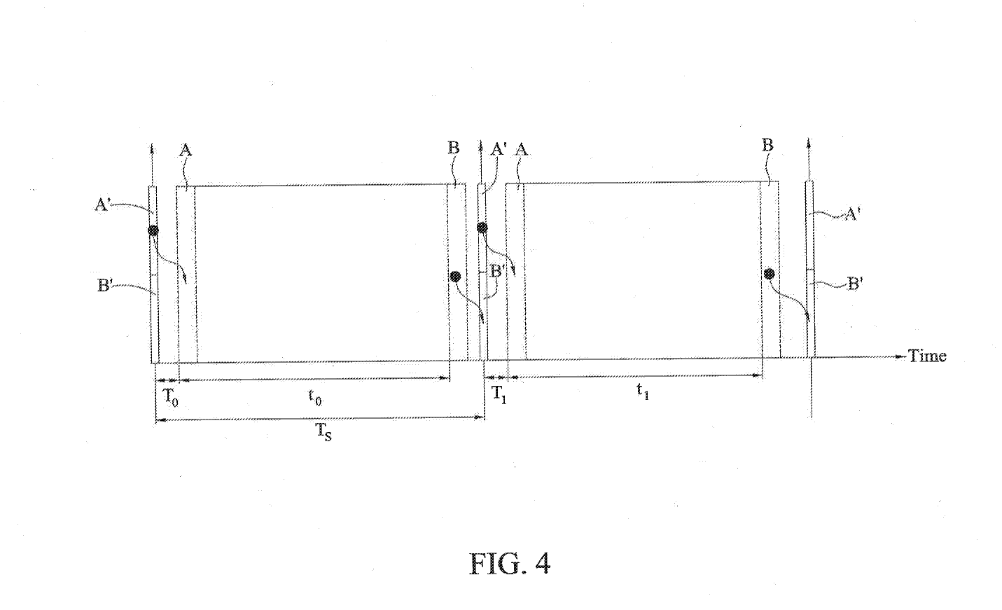

Referring to FIG. 4, the effect of the real-time sampling device and method of the present disclosure is illustrated. In FIG. 4, vertical upward arrows indicate the interrupt signal sent from the timer; the period of the interrupt signal is Ts; dotted boxes A and B indicate operations of retrieving the processed data from the first register and outputting the processed data calculation value in the third register by software in the prior art, respectively; and solid. boxes A′ and B′ indicate operations of retrieving the processed data from the second register and using the trigger output element to output the processed data calculation value in the third register according to the present disclosure, respectively. It can be seen from FIG. 4 that, in the prior art, there are delays T₀ and T₁ between the times at which the processed data are retrieved and the processed data calculation value is outputted and the time at which the interrupt signal is sent, and there are delays t₀ and t₁ between the retrieving operation and the outputting operation. On the contrary, in the present disclosure, there is no delay between the times at which the processed data are retrieved and the Processed data calculation value is outputted and the time at which the interrupt signal is sent, and there is no time gap between the retrieving operation and the outputting operation.

Therefore, the real-time sampling device and method of the present disclosure can be applied to the digital servo controlled system, and real-time sampling of the controlled subject can be achieved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A real-time sampling device for being coupled to a processing unit, the real-time sampling device comprising:
a timer for outputting an interrupt signal;
a first register for externally receiving a first input signal and processing the first input signal to produce first processed data;
a second register coupled to the first register and the timer for retrieving the first processed data from the first register upon receiving the interrupt signal sent from the timer, and the processing unit, upon receiving the interrupt signal sent from the timer, retrieving the first processed data from the second register and performing calculation thereon to produce a first processed data calculation value;
a third register coupled with the processing unit for receiving and temporarily storing the first processed data calculation value produced by the processing unit; and
a trigger output element coupled with the third register and the timer for outputting the first processed data calculation value in the third register upon receiving the interrupt signal sent from the timer.

2. The real-time sampling device of claim 1, wherein the first input signal is an encoder input signal.

3. The real-time sampling device of claim 2, wherein the first register a timing register, the second register is a latch register, and the real-time sampling device further includes a decoder including the timing register and the latch register.

4. The real-time sampling device of claim 1, wherein the first input signal is an analog input signal.

5. The real-time sampling device of claim 4, wherein the first register is a data register, the second register is a latch register, and the real-time sampling device further includes an A/D converter including the data register and the latch register.

6. The real-time sampling device of claim 1, wherein the third register is a data register, the first processed data calculation value is an analog output signal, and the real-time sampling device further includes a D/A converter including the data register and the trigger output element.

7. The real-time sampling device of claim 1, further comprising:
a fourth register for externally receiving a second input signal and processing the second input signal to produce second processed data;
a fifth register coupled to the fourth register and the tinier for retrieving the second processed data from the fourth register upon receiving the interrupt signal sent from the timer, and the processing unit, upon receiving the interrupt signal sent from the timer, retrieving the second processed data from the fifth register and performing calculation thereon to produce a second processed data calculation value,
wherein the third register receives and temporarily stores the second processed data calculation value produced by the processing unit, and the trigger output element outputs the second processed data calculation value in the third register upon receiving the interrupt signal sent from the timer.

8. The real-time sampling device of claim 1, further comprising a bus controller coupled with the processing unit, the timer, the first register, the second register and the third register, and the processing unit outputs bus signals through the bus controller to drive the processing unit, the timer, the first register, the second register and the third register.

9. A real-time sampling method, comprising the following steps of:
(1) receiving a first input signal and processing the first input signal by a first register to produce first processed data;
(2) retrieving the first processed data from the first register by a second register upon receiving an interrupt signal, and upon receiving the interrupt signal, retrieving the first processed data from the second register and performing calculation by a processing unit to produce a first processed data calculation value and transmit the first processed data calculation value to a third register;
(3) temporarily storing the first processed data calculation value produced by the processing unit by the third register receiving order to transmit the first processed data calculation value to a trigger output element; and
(4) outputting the first processed data calculation value in the third register by the trigger output element upon receiving the interrupt signal.

10. The real-time sampling method of claim 9, wherein step (1) further includes receiving a second input signal and processing the second input signal by a fourth register to produce second processed data; step (2) further includes retrieving the second processed data from the fourth register by a fifth register upon receiving the interrupt signal, and upon receiving the interrupt signal, retrieving the second processed data from the fifth register and performing calculation by the processing unit to produce a second processed data calculation value, and transmit the second processed data calculation value to the third. register; step (3) further includes temporarily storing the second processed data calculation value produced by the processing unit by the third register in order to transmit the second processed data calculation value to the trigger output element; and step (4) further include outputting the second processed data calculation value in the third register by the trigger output element upon receiving the interrupt signal.
